(19) United States
(12) Patent Application Publication
(10) Pub. No.: US 2025/0042005 A1
(43) Pub. Date: Feb. 6, 2025

(54) MULTI-SEGMENT BENDABLE JOINT

(71) Applicants: Yi-Fu Chen, TAICHUNG CITY (TW); He-Qian Chen, Taichung City (TW)

(72) Inventors: Yi-Fu Chen, TAICHUNG CITY (TW); He-Qian Chen, Taichung City (TW)

(21) Appl. No.: 18/228,681

(22) Filed: Aug. 1, 2023

(51) Int. Cl. B25B 23/00

(52) U.S. Cl. CPC B25B 23/0028

(57) ABSTRACT

The present invention provides a multi-segment bendable joint, comprising: a jointer, having a rod portion, a first ball head and a second ball head connected at two ends of the rod portion; a first connector, at opposite ends thereof, with a first connecting portion and a first joint slot for receiving the first ball head therein, respectively; and a second connector, at opposite ends thereof, with a second connecting portion and a second joint slot for receiving the second ball head therein, respectively. When one of the first and second connectors is linked to a wrench body and the other acts as a socket, two-segment bending between the socket and the wrench body is allowed, resulting in larger bending angle between the socket and the wrench body compared to conventional products.

### BACKGROUND OF THE INVENTION

### Fields of the Invention

The present invention relates to a multi-segment bendable joint for installation on a head of a hand tool, facilitating the user's application of force to a target object (e.g., a screw).

### Descriptions of Related Art

Hand tools are essential tools utilized for equipment maintenance and installation, such as wrenches commonly used for loosening, tightening screws, nuts, and so on. However, the commonly used open-end wrenches require a larger operational space for smooth and continuous usage. When used in confined areas, they are limited by the environment, necessitating the removal of the wrench after slight angular movement and repositioning on the screw, resulting in time-consuming tasks. To address this issue, those skilled in the field have further developed ratchet wrenches combined with socket joints, which enable users to rotate the wrench continuously without detaching it from the screw. Furthermore, by merely changing the socket joint to match the specific screw size, screws of different specifications can be accommodated quickly and conveniently compared to regular open-end wrenches.

Nonetheless, traditional ratchet wrenches feature a fixed angle between the socket joint and the wrench body. Accordingly, on the market, a ball joint has been introduced between the socket joint and the wrench body, allowing the socket joint to bend relative to the wrench body. This type of structure, while capable of reaching more positions compared to the traditional wrenches with no bendable structure, still has limitations in terms of the socket joint's ability to bend relative to the main body of the wrench, leaving room for further enhancement.

Considering the aforementioned challenges, it remains a key issue demanding prompt resolution for the industry to improve the bending angle of the socket relative to the wrench body.

### SUMMARY OF THE INVENTION

The present invention utilizes a jointer with a first ball head and a second ball head at its both ends to address the conventional issues. As the jointer have the first ball head and the second ball head at both ends thereof, it can be assembled into a first joint slot of a first connector and a second joint slot of a second connector, enabling the jointer to bend once relative to the first connector, while also allowing another bending between the second connector and the jointer. When one of the first and second connectors is linked to a wrench body and the other acts as a socket, two-segment bending between the socket and the wrench body is allowed, resulting in larger bending angle between the socket and the wrench body compared to conventional products. Therefore, the present invention effectively improves the bending angle of the socket relative to the wrench body compared to conventional products.

To achieve the above objectives and effects, the present invention provides a multi-segment bendable joint, comprising: a jointer, having a rod portion, a first ball head and a second ball head connected at two ends of the rod portion; a first connector, at opposite ends thereof, with a first connecting portion and a first joint slot for receiving the first ball head therein, respectively; and a second connector, at opposite ends thereof, with a second connecting portion and a second joint slot for receiving the second ball head therein, respectively.

Furthermore, the bending angle between the jointer and the first connector can range from 0 degree to 22.5 degrees.

Additionally, the bending angle between the jointer and the second connector can range from 0 degree to 22.5 degrees.

Moreover, the bending angle between the jointer and the first connector can range from 0 degree to 45 degrees.

Also, the bending angle between the jointer and the second connector can range from 0 degree to 45 degrees.

### BRIEF DESCRIPTION OF THE DRAWINGS

FIG. 1 is a perspective schematic view of the present invention.

FIG. 2 is an exploded schematic view of the present invention.

FIG. 3 is a cross-sectional schematic view taken along line III-III of FIG. 1.

FIG. 4 is a schematic view for illustration of bending of a jointer relative to a first connector in the present invention.

FIG. 5 is a schematic view for illustration of bending of a second connector relative to a jointer in the present invention.

FIG. 6 is an exploded schematic view for illustration of a wrench body and the present invention.

FIG. 7 is a schematic view for illustration of exerting force on a target object using a wrench body and the present invention.

### DETAILED DESCRIPTION OF THE PREFERRED EMBODIMENT

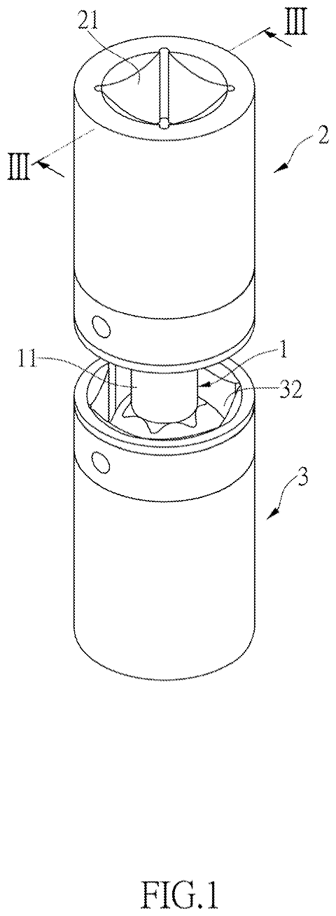

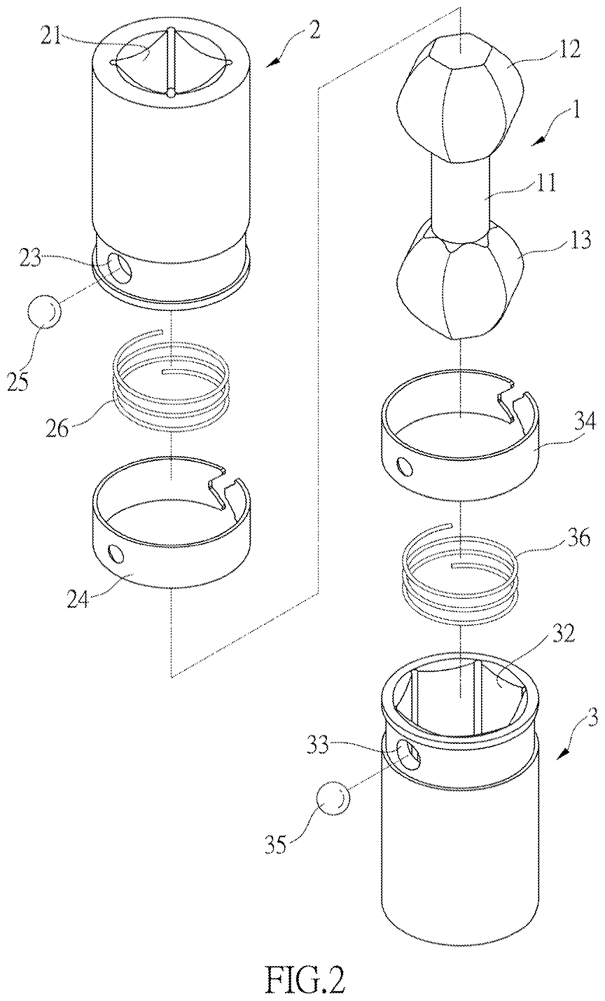

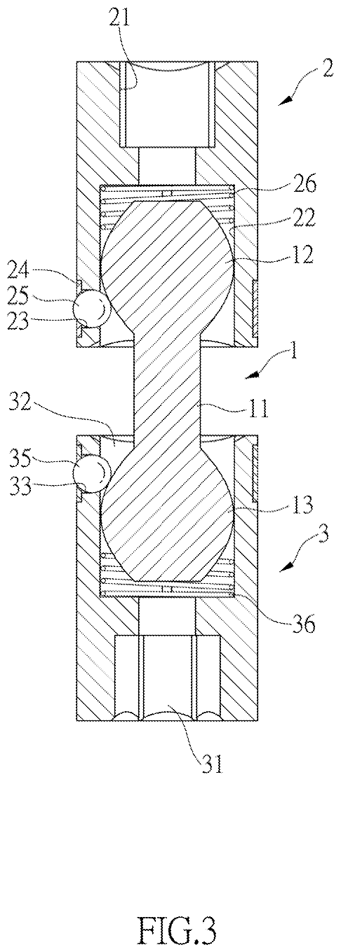

For a more detailed understanding of the implementations of the present invention, please refer to the accompanying illustrations from FIG. 1 to FIG. 5. The present invention provides a multi-segment bendable joint, including: a jointer 1 having a rod portion 11 and a first ball head 12 and a second ball head 13 connected at two ends of the rod portion 11; a first connector 2 with a first connecting portion 21 and a first joint slot 22 for receiving the first ball head 12 therein at its opposite ends, respectively; and a second connector 3 with a second connecting portion 31 and a second joint slot 32 for receiving the second ball head 13 therein at its opposite ends, respectively.

The first ball head 12 is disposed in the first joint slot 22 by being inserted entirely into the first joint slot 22. The first connector 2 has a first through-hole 23 that extends through the first joint slot 22 and the outer wall surface. The first through-hole 23 has slightly reduced diameter at its opening near the first joint slot 22. When a first anti-loosening bead 25 is placed into the first through-hole 23, the anti-loosening bead 25 would protrude slightly into the first joint slot 22, thereby limiting the first ball head 12 from detaching from the first joint slot 22. Furthermore, the first connector 2 is equipped with a first retaining ring 24 around the outer periphery of the corresponding first through-hole 23 to prevent the first anti-loosening bead 25 from detaching outwardly. A first spring 26 is disposed between the first ball head 12 and the deepest part of the first joint slot 22 to stabilize the bending angle between the first ball head 12 and the first connector 2. Similarly, the second ball head 13 is installed in the second joint slot 32 in the same manner as those described above using the second through-hole 33, the second retaining ring 34, the second anti-loosening bead 35, and the second spring 36.

Moreover, the peripheral ring of the first ball head 12 has multiple curved surfaces so that the outer contour of the first ball head 12 is presented a polygonal shape, such as a hexagon exemplified in this embodiment. In practice, it can also be quadrilateral, dodecagonal, etc. The structural design of the second ball head 13 is the same as that of the first ball head 12.

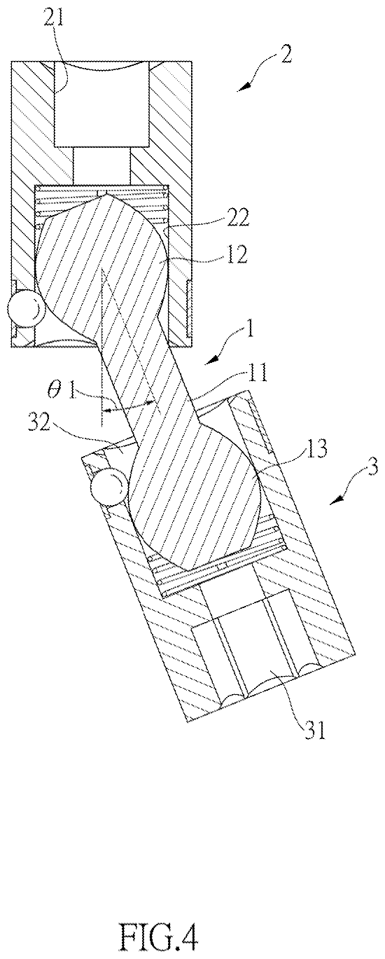

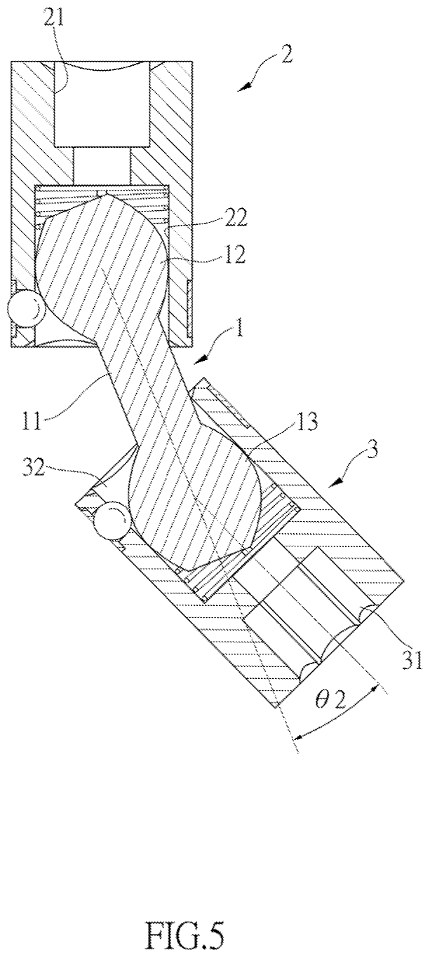

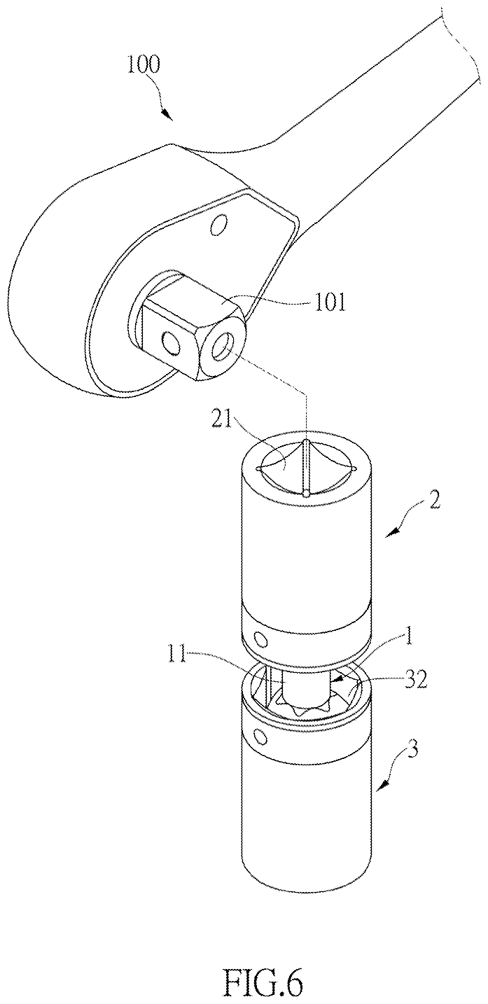

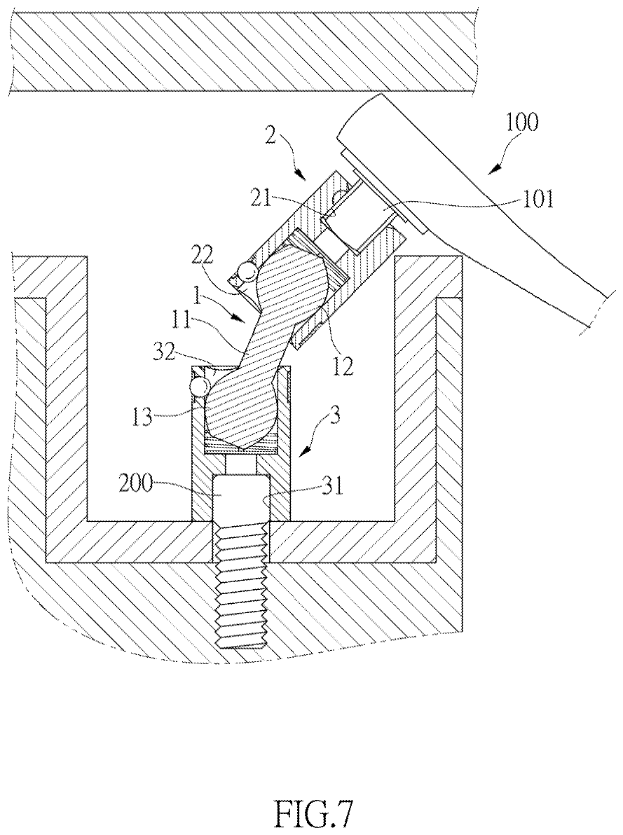

Continuing with the above content, the present invention utilizes a jointer 1 with the first ball head 12 and the second ball head 13 at its both ends to address the conventional issues. As both ends of the jointer 1 have the first ball head 12 and the second ball head 13, which can be respectively assembled into the first joint slot 22 of the first connector 2 and the second joint slot 32 of the second connector 3, as shown in FIG. 4, the jointer 1 can bend once relative to the first connector 2, while, as shown in FIG. 5, another bending between the second connector 3 and the jointer 1 is allowed. In this embodiment, as shown in FIGS. 6 and 7, the first connecting portion 21 of the first connector 2 is linked to the mounting portion 101 of the wrench body 100, and the second connecting portion 31 of the second connector 3 serves as a socket connected to the target object 200, for example. Due to the two bending motions between the second connector 3 used as the socket and the wrench body 100, the bending angle between the second connector 3 used as the socket and the wrench body 100 is larger compared to conventional products. Accordingly, the present invention exhibits novelty and inventive step by improved bending angle of the socket relative to the wrench body.

In this specification, the terms “first” and “second” used herein are for clear understanding of the present invention, and can be interchangeable based on design requirements and implementations.

Further, as shown in FIG. 4, the bending angle θ1 between the jointer 1 and the first connector 2 can range from 0 degrees to 22.5 degrees, while, as shown in FIG. 5, the bending angle θ2 between the jointer 1 and the second connector 3 can range from 0 degrees to 22.5 degrees. Therefore, the maximum included angle between the second connector 3 and the first connector 2 can reach 45 degrees, which is twice the bending angle achievable with the conventional single-segment bending structure.

Additionally, as shown in FIG. 4, the bending angle θ1 between the jointer 1 and the first connector 2 can range from 0 degrees to 45 degrees, while, as shown in FIG. 5, the bending angle θ2 between the jointer 1 and the second connector 3 can range from 0 degrees to 45 degrees. As a result, the maximum included angle between the second connector 3 and the first connector 2 can reach 90 degrees. For implementation, larger bending angles can be achieved by merely changing the curvature of the peripheral curved surfaces of the first ball head 12 and the second ball head 13 of the present invention. In terms of data, the two-segment bending design of the present invention can achieve twice the bending angle of the conventional single-segment bending structure.

What is claimed is:

1. A multi-segment bendable joint, comprising:
a jointer, having a rod portion, a first ball head and a second ball head connected at two ends of the rod portion;
a first connector, at opposite ends thereof, with a first connecting portion and a first joint slot for receiving the first ball head therein, respectively; and
a second connector, at opposite ends thereof, with a second connecting portion and a second joint slot for receiving the second ball head therein, respectively.

2. The multi-segment bendable joint as claimed in claim 1, wherein a bending angle of from 0 degree to 22.5 degrees is allowed between the jointer and the first connector.

3. The multi-segment bendable joint as claimed in claim 1, wherein a bending angle of from 0 degree to 22.5 degrees is allowed between the jointer and the second connector.

4. The multi-segment bendable joint as claimed in claim 1, wherein a bending angle of from 0 degree to 45 degrees is allowed between the jointer and the first connector.

5. The multi-segment bendable joint as claimed in claim 1, wherein a bending angle of from 0 degree to 45 degrees is allowed between the jointer and the second connector.
